(19) United States
(12) Patent Application Publication
(10) Pub. No.: US 2018/0037161 A1
(43) Pub. Date: Feb. 8, 2018

(54) TRUCK BED RAIL LIGHT ASSEMBLY

(71) Applicant: Iddea California, LLC, Brea, CA (US)

(72) Inventor: Timothy J. Wymore, Yorba Linda, CA (US)

(21) Appl. No.: 15/225,974

(22) Filed: Aug. 2, 2016

(51) Int. Cl. B60Q 3/06; F21S 8/10; F21S 9/02; B60Q 1/26; B60Q 1/00

(52) U.S. Cl. CPC B60Q 3/06; B60Q 1/2661; B60Q 1/0094; F21S 9/02; F21S 48/00; F21Y 2115/10

(57) ABSTRACT

A truck bed rail light assembly includes a first end, a second end, and a body extending between the first end and the second end. One or more light modules are coupled to the body. Each light module includes a light element. One or more switch modules are coupled to the body. Each switch module includes a switch for selective activation of the light element. The truck bed rail light assembly also includes a battery module. The battery module includes a battery. The switch is electrically connected between the battery and the light element. The battery is at least partially contained within the body.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### Technical Field

The present disclosure relates to lighting systems for vehicles. More particularly, the present disclosure relates to a truck bed rail light assembly.

### Discussion of Related Art

One common truck accessory is a so-called “bed rail,” an accessory that is often formed of tubular enclosure, or the like, that is bolted to an upper surface of the side walls of the truck bed (also referred to as side rails). Once in place, truck bed rails help shield the pickup's side rails from falling/tipping freight and create extra tie-down points.

Truck beds may be accessorized with bed rails to improve the look and function of a pickup truck. For example, truck bed rails may have a mirror-polished finish. Truck bed rails may enable persons to pull themselves inside the truck bed, e.g., to access a tool box, or to tie down loads for secure transportation.

Two main styles of truck bed rails are drill style truck bed rails and stake pocket mount bed rails, though there are other types on the market. Drill style truck bed rails are the sportier style, with additional areas for tie down attachment or handgrips for riders in the back of the truck. Another aspect is that drill style truck bed rails do not extend the entire length of the bed. Instead, the end of the rail typically falls just shy of the last stake pocket. Normally, some drilling for the mounting holes is required on the bed to accommodate mounting.

Stake pocket mount bed rails extend the entire length of the truck bed and mount in the last stake pocket. Stake pocket mount bed rails are popular primarily because drill holes are not required for mounting. Stake pocket mount bed rails are generally easy to install and do not require a drill as the rails are designed to bolt right into the bed pockets.

Typically, a truck bed for sports trucks, utility trucks, and the like includes a floor or bottom wall, a front wall located to the rear of the cab, side walls, and a tailgate moveable from a closed to a down position. Often there is a need to illuminate the cargo box of pick-up trucks and other utility-type vehicles. A cargo box light for trucks may be particularly useful under reduced light conditions, such as after daylight hours, allowing safe access to the truck cargo box and the loading/unloading of objects therefrom. Light-emitting diodes (LED) cargo box lights for pickups are known and include LED truck bed light kits, LED light strips and tailgate running lights.

A need exists for improved lighting systems for trucks, trailers, and other vehicles with open cargo enclosures.

### BRIEF SUMMARY

According to an aspect of the present disclosure, a truck bed rail light assembly includes a first end, a second end, and a body extending between the first end and the second end. One or more light modules are coupled to the body. Each light module includes a light element. One or more switch modules are coupled to the body. Each switch module includes a switch for selective activation of the light element. The truck bed rail light assembly also includes a battery module. The battery module includes a battery. The switch is electrically connected between the battery and the light element. The battery is at least partially contained within the body.

According to another aspect of the present disclosure, a truck bed rail light assembly includes: a first end; a second end; a body extending between the first end and the second end; a first light module; a first switch module; a second light module; a second switch module; and a battery module including a battery. The first light module includes a first light housing element coupled to the body and a first light element coupled to the first light housing element. The first switch module is coupled to the body. The first switch module includes a first switch for selective activation of the first light element. The second light module includes a second light housing element coupled to the body and a second light element coupled to the second light housing element. The second switch module is coupled to the body. The second switch module includes a second switch for selective activation of the second light element. The battery is at least partially contained within the body. The first switch is electrically connected between the battery and the first light element. The second switch is electrically connected between the battery and the second light element.

### BRIEF DESCRIPTION OF THE DRAWINGS

These and other features and advantages of the various truck bed rail light assembly embodiments disclosed herein will be better understood with respect to the following description and drawings, in which like reference numerals may refer to similar or identical elements throughout the description of the figures, and in which:

FIG. 1 is a perspective view illustrating twin, truck bed rail light assemblies installed to the side rails of a truck bed in accordance with an embodiment of the present disclosure;

FIG. 2 is a perspective view of a truck bed rail light assembly of FIG. 1, with parts separated, in accordance with an embodiment the present disclosure;

FIG. 3 is a perspective view of the truck bed rail light assembly of FIG. 2 in an assembled configuration in accordance with an embodiment of the present disclosure; and

FIG. 4 is circuit diagram of a lighting system for use with a truck bed rail light assembly in accordance with an embodiment of the present disclosure.

### DETAILED DESCRIPTION

Hereinafter, embodiments of a truck bed rail light assembly are described with reference to the accompanying drawings.

This description may use the phrases “in an embodiment,” “in embodiments,” “in some embodiments,” or “in other embodiments,” which may each refer to one or more of the same or different embodiments in accordance with the present disclosure.

It is to be understood that the terminology used herein is for the purpose of describing particular embodiments only, and is not intended to be limiting. As it is used in this description, “cargo area” may include the open cargo area of a truck, trailer, and the like. As used herein, the term “truck” generally refers to land-based motor vehicles with an open rear cargo box often referred to as a “pickup truck,” “pickup” or “pick-up”. The open rear cargo box is often referred to as the “bed” of the truck.

As it is used in this description, “light source” generally refers to all illumination sources, such as for example, photo-luminescent sources, fluorescent sources, phosphorescence sources, lasers, electro-luminescent sources, such as electro-luminescent lamps, and light-emitting diodes. As it is used in this description, “light-emitting diode” generally refers to any system that is capable of receiving an electrical signal and producing a color of light in response to the signal. Thus, “light-emitting diode,” as used herein, includes light-emitting diodes (LEDs) of all types, including white LEDs, infrared LEDs, ultraviolet LEDs, visible color LEDs, light-emitting polymers, semiconductor dies that produce light in response to current, organic LEDs, electro-luminescent strips, silicon based structures that emit light, and other such systems.

As it is used in this description, “transmission line” generally refers to any transmission medium that can be used for the propagation of signals from one point to another. A transmission line may be, for example, a wire, two or more conductors separated by an insulating medium, a fiber optic line and/or fiber optic bundles.

As used herein, the term “battery” generally refers to any electrical storage device, e.g., disposable battery, rechargeable battery, battery pack, etc. As it is used in this description, “switch” or “switches” generally refers to any electrical actuators, mechanical actuators, electro-mechanical actuators (rotatable actuators, pivotable actuators, toggle-like actuators, buttons, etc.), optical actuators, or any suitable device that generally fulfills the purpose of connecting and disconnecting electronic devices, or component thereof, transmission line or connections.

Various embodiments of the present disclosure provide a truck bed rail light assembly for selectively illuminating a truck bed. Embodiments of the presently-disclosed truck bed rail light assembly may be affixed to a truck bed rail. Elements of the presently-disclosed truck bed rail light assembly may be powered by a disposable or rechargeable battery, housed within an elongate body of the truck bed rail light assembly.

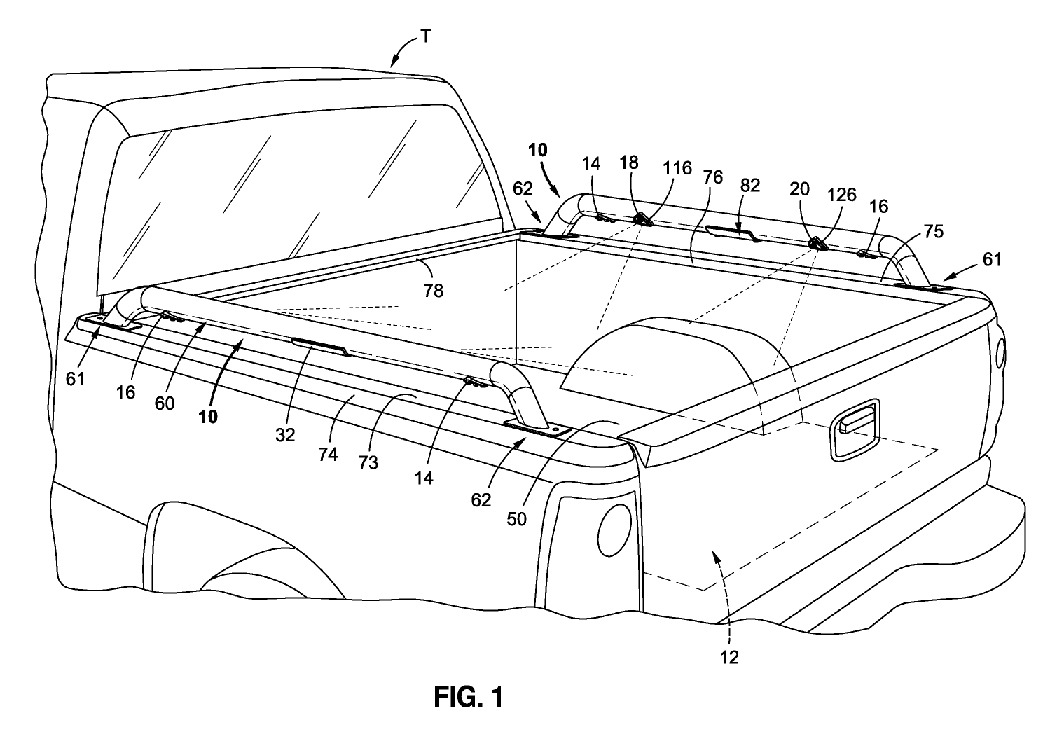

The presently-disclosed truck bed rail light assembly is referred to generally in FIGS. 1-3 by the reference numeral 10 and is intended to provide a combined truck bed rail and battery-powered lighting system. In the embodiment illustrated in FIGS. 1-3, the truck bed rail light assembly 10 includes a first light module 20, a first switch module 16, a second light module 18, a second switch module 14, and a battery module 82. It is to be understood that the truck bed rail light assembly 10 may be installed and used on various types of vehicles and should not be construed to be limited to only pickup trucks.

The truck bed rail light assembly 10 includes a first end 61, a second end 62, and a body 60 extending therebetween. The truck bed rail light assembly 10 is designed to be mountable on the side rails of a truck bed, in a first orientation or a second orientation (as described below), with the first light module 20 and the second light module 18 facing toward the interior of the truck bed for illumination thereof. Those skilled in the art will recognize that the size and shape of the truck bed rail light assembly 10 may vary according to truck model, truck manufacturer, style of truck, etc. In some embodiments, the body 60 has a generally tubular shape, and may have a variety of finishes, e.g., chrome, stainless, or power-coated black.

In FIG. 1, two truck bed rail light assemblies 10 are shown installed on a truck T. One truck bed rail light assembly 10 is mounted on the upper surface 73 of the left-hand (i.e., driver side) side rail 74 (also referred to herein as the first side rail 74) and one truck bed rail light assembly 10 is mounted on the upper surface 75 of the right-hand side rail 76 (also referred to herein as the second side rail 76) for selectively illuminating the bed interior portion 50 of the truck bed 12. In more detail, the truck bed rail light assembly 10 shown in FIG. 1 mounted on the first side rail 74 is arranged in a first orientation, wherein the first end 61 of the body 60 is proximate the forward-end of a truck bed (i.e., cab-end 78) and the second end 62 of the body 60 is proximate the rear-end of the truck bed 12, such that, in the first orientation, a first light element 126 of the first light module 20 and a second light element 116 of the second light module 18 face toward the bed interior portion 50 of the truck bed 12. The truck bed rail light assembly 10 shown in FIG. 1 mounted on the second side rail 76 is arranged in a second orientation, wherein the first end 61 of the body 60 is proximate the rear-end of the truck bed and the second end 62 is proximate the forward-end of the truck bed, such that, in the second orientation, the first light element 126 of the first light module 20 and the second light element 116 of the second light module 18 face toward the bed interior portion 50 of the truck bed 12.

The installation and use of two truck bed rail light assemblies 10, as illustratively depicted in FIG. 1, allows a truck bed 12 to be viewable in reduced light conditions by using the first light module 20 and/or the second light module 18 to illuminate the bed interior portion 50 of the truck bed 12, e.g., to facilitate the inspection of cargo, loading, unloading, etc. In the embodiment illustrated in FIGS. 1-3, the first light element 126 and the second light element 116 are positioned approximately 45 degrees to a horizontal plane (e.g., a horizontal plane parallel to a plane defined by an upper surface 73 of a side rail) so as to enable the illumination of the bed interior portion 50 of the truck bed 12.

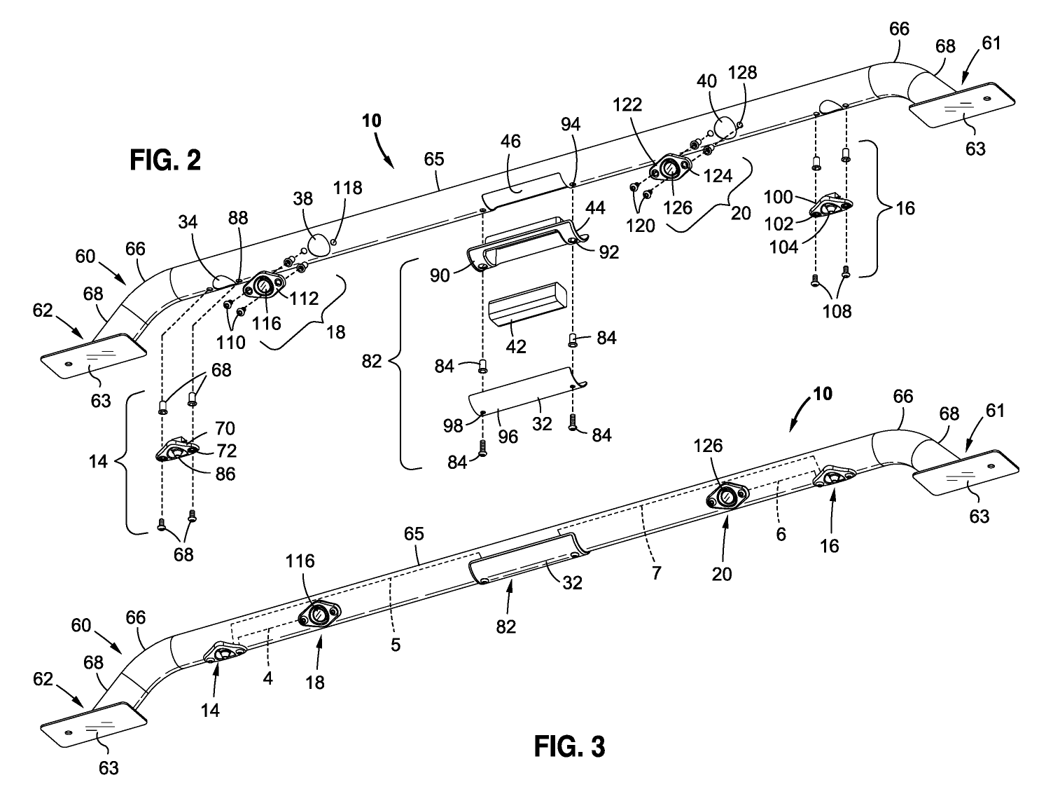

In some embodiments, as shown for example in FIG. 1, the second switch module 14 and the first switch module 16 are disposed on a lower portion of the body 60 near the first end 61 and the second end 62, respectively, at locations that are easily accessible from the exterior of the truck bed 12. A battery cover 32 is removably attached to the body 60, allowing for the installation, removal and/or replacement of a battery 42 (shown in FIG. 2).

In FIG. 2, the parts of the first light module 20, the first switch module 16, the second light module 18, the second switch module 14, and the battery module 82 are shown for installation with the body 60.

In some embodiments, as shown for example in FIG. 2, the first light module 20 includes a light housing element 122 configured to house the first light element 126 and having two apertures defined therethough for receiving a pair of fasteners 120 used to attach the light housing element 122 to the body 60. In an embodiment, the body 60 includes two apertures 124 for receiving the fasteners 120, and includes an aperture 40 for receiving a portion of the light housing element 122 (and/or a portion of the first light element 126) therein and/or to enable electrical connections to the first light element 126.

The first switch module 16 includes a first switch 104. A switch housing element 100 is operably associated with the first switch 104 and has two apertures defined therethough for receiving a pair of fasteners 108 used to attach the switch housing element 100 to the body 60. In an embodiment, the body 60 includes two apertures for receiving the fasteners 108, and includes an aperture for receiving a portion of the switch housing element 100 (and/or a portion of the first switch 104) therein and/or to enable electrical connections to the first switch 104.

The second light module 18 includes a second light element 116. In some embodiments, as shown for example in FIG. 2, the second light module 18 includes a light housing element 112 configured to house the second light element 116 and having two apertures defined therethough for receiving a pair of fasteners 110 used to attach the second light module 18 to the body 60. In an embodiment, the body 60 includes two apertures 118 for receiving the fasteners 110, and includes an aperture 38 for receiving a portion of the light housing element 112 (and/or a portion of the second light element 116) therein and/or to enable electrical connections to the second light element 116.

The second switch module 14 includes a second switch 86. A switch housing element 70 is operably associated with the second switch 86 and has two apertures defined therethough for receiving a pair of fasteners 68 used to attach the switch housing element 70 to the body 60. In an embodiment, the body 60 includes two apertures 88 for receiving the fasteners 68, and includes an aperture 34 for receiving a portion of the switch housing element 70 (and/or a portion of the second switch 86) therein and/or to enable electrical connections to the second switch 86.

The battery module 82 includes a battery 42, a battery housing element 90, and a battery cover 32. The battery housing element 90 includes a recess configured to contain the battery 42, or portion thereof, and has two apertures defined therethough for receiving a pair of fasteners 84 used to attached the battery housing element 90 to the body 60. In an embodiment, the body 60 includes two apertures 94 for receiving the fasteners 84, and includes an aperture 46 for receiving a portion of the battery housing element 90 (and at least a portion of the battery 42) therein and/or to enable electrical connections to the battery 42.

In some embodiments, the first switch module 16 of the truck bed rail light assembly 10 is configured for use to turn on and off the first light module 20, and the second switch module 14 is configured for use to turn on and off the second light module 18. Those skilled in the art will recognize that the first switch module 16 may be configured to turn on and off the first light module 20 and the second light module 18 in unison, and/or the second switch module 14 may be configured to turn on and off the first light module 20 and the second light module 18 in unison.

In an embodiment, as shown for example in FIG. 3, the second switch module 14 is electrically coupled to the battery module 82 with a transmission line 5 and electrically coupled to the second light module 18 with a transmission line 4, and the first switch module 16 is electrically coupled to the battery module 82 with a transmission line 7 and electrically coupled to the first light module 20 with a transmission line 6. In some embodiments, the truck bed rail light assembly 10 may include an audio transducer (not shown) that accepts sound input in the form of voice commands, the processing of which may be performed by with a programmable integrated circuit device such as a microcontroller or control processor (not shown).

It is to be understood that the dashed lines indicative of electrical connections (e.g., electrical conductors) between various components of the truck bed rail light assembly 10 are merely illustrative and non-limiting examples of electrical connections, and that truck bed rail light assembly embodiments of the present disclosure may utilize many different configurations of electrical connections, some with additional, fewer, or different electrical connections than depicted in FIG. 3.

The body 60 may be formed from a single piece of tubular metal. In an embodiment, the body 60 is tubular stainless steel. The body 60 may include a plurality of sections. In an embodiment, as shown for example in FIGS. 2 and 3, the body 60 includes two end portions 68, two curved portions 66 which are connected to the end portions 68, and a center portion 65 extending between the curved portions 66. In embodiments, the center portion 65 and the curved portions 66 are an integrally-formed single piece. Affixed to each end portion 68 is a base member 63 used to fasten the truck bed rail light assembly 10 to the first side rail 74 or the second side rail 76. It is to be understood that the size and shape of the center portion 65, the curved portions 66, the end portions 68, and the base members 63 may be varied from the configuration shown in FIGS. 2 and 3. Those skilled in the art will recognize that the body 60 may be formed of various materials, e.g., metals, plastics, composites, and other materials with suitable material characteristics. It is also to be understood that the elongate body of the truck bed rail light assembly 10 should not be construed to be limited to only a tubular body.

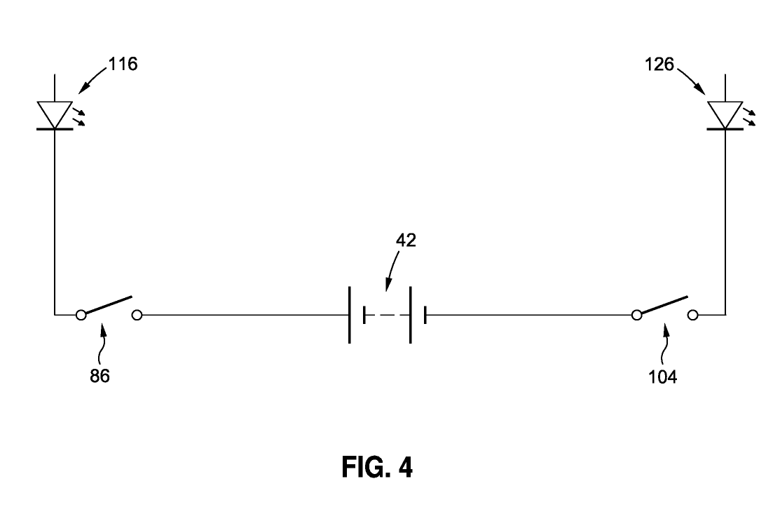

In FIG. 4, a circuit diagram is shown depicting an embodiment of a lighting system for use with the body 60. A first switch 104 is electrically connected between a battery 42 and a first light-emitting diode (LED) 126. A second switch 86 is electrically connected between the battery 42 and a second LED 116.

Although embodiments have been described in detail with reference to the accompanying drawings for the purpose of illustration and description, it is to be understood that the disclosed processes and systems are not to be construed as limited thereby. It will be apparent to those of ordinary skill in the art that various modifications to the foregoing embodiments may be made without departing from the scope of the disclosure.

1. A truck bed rail light assembly, comprising:
a first end;
a second end;
a body extending between the first end and the second end;
at least one light module coupled to the body, wherein the at least one light module includes a light element;
at least one switch module coupled to the body, wherein the at least one switch module includes a switch for selective activation of the light element; and
a battery module including a battery, wherein the battery is at least partially contained within the body,
wherein the switch is electrically connected between the battery and the light element.

2. The truck bed rail light assembly of claim 1, wherein the battery module includes a battery cover that is removably attached to either or both of the battery module and the body.

3. The truck bed rail light assembly of claim 1, wherein the battery is a rechargeable battery.

4. The truck bed rail light assembly of claim 1, wherein the light element is a light-emitting diode (LED).

5. The truck bed rail light assembly of claim 1, wherein the body includes a first end portion proximate the first end, wherein a first base member is attached to the first end portion and configured for attachment to a side rail of a truck.

6. The truck bed rail light assembly of claim 5, wherein the body further includes a second end portion proximate the second end, wherein a second base member is attached to the second end portion and configured for attachment to the side rail of the truck.

7. The truck bed rail light assembly of claim 6, wherein the body further includes a first curved portion and a second curved portion, wherein the first curved portion is connected to the first end portion and the second curved portion is connected to the second end portion.

8. The truck bed rail light assembly of claim 1, wherein the at least one switch module is disposed on a lower portion of the body and located proximate the first end or the second end.

9. The truck bed rail light assembly of claim 1, wherein the light element is positioned approximately 45 degrees to a horizontal plane.

10. A truck bed rail light assembly, comprising:
a first end;
a second end;
a body extending between the first end and the second end;
a first light module, including:
a first light housing element coupled to the body; and
a first light element coupled to the first light housing element;
a first switch module coupled to the body, wherein the first switch module includes a first switch for selective activation of the first light element;
a second light module, including:
a second light housing element coupled to the body; and
a second light element coupled to the second light housing element;
a second switch module coupled to the body, wherein the second switch module includes a second switch for selective activation of the second light element; and
a battery module including a battery, wherein the battery is at least partially contained within the body,
wherein the first switch is electrically connected between the battery and the first light element, and wherein the second switch is electrically connected between the battery and the second light element.

11. The truck bed rail light assembly of claim 10, wherein the battery is a rechargeable battery.

12. The truck bed rail light assembly of claim 10, wherein the first light element and the second light element are LEDs.

13. The truck bed rail light assembly of claim 10, wherein the body includes a first end portion proximate the first end and a second end portion proximate the second end.

14. The truck bed rail light assembly of claim 13, wherein the body further includes a first base member attached to the first end portion and a second base member attached to the second end portion.

15. The truck bed rail light assembly of claim 14, wherein the body further includes a first curved portion and a second curved portion, wherein the first curved portion is connected to the first end portion and the second curved portion is connected to the second end portion.

16. The truck bed rail light assembly of claim 15, wherein the body further includes a center portion extending between the first curved portion and the second curved portion.

17. The truck bed rail light assembly of claim 10, wherein the first switch module is located proximate the first end and the second switch module is located proximate the second end.
